(19) United States
(12) Patent Application Publication
(10) Pub. No.: US 2025/0246180 A1
(43) Pub. Date: Jul. 31, 2025

(54) INFORMATION PROCESSING SYSTEM, INFORMATION PROCESSING APPARATUS, INFORMATION PROCESSING METHOD, AND RECORDING MEDIUM

(71) Applicant: NEC Corporation, Minato-ku, Tokyo (JP)

(72) Inventor: Hitoshi Yamamoto, Tokyo (JP)

(73) Assignee: NEC Corporation, Minato-ku, Tokyo (JP)

(21) Appl. No.: 18/701,638

(22) PCT Filed: Oct. 28, 2021
(86) PCT No.: PCT/JP2021/039899

§ 371 Date: Apr. 16, 2024

(51) Int. Cl. G10L 15/06; G10L 13/02; G10L 13/08

(52) U.S. Cl. CPC G10L 15/063; G10L 13/02; G10L 13/08; G10L 2015/0635

(57) ABSTRACT

An information processing system includes: a first text data acquisition unit that acquires first text data; a speech data generation unit that generates first speech data corresponding to the first text data; a context symbol acquisition unit that acquires a context symbol corresponding to a word included in the first text data; a text data generation unit that generates second text data by inserting the context symbol into the first text data; and a learning unit that performs learning of a speech recognition unit that generates, from speech data, text data corresponding to the speech data, by using the first speech data and the second text data as inputs.

### TECHNICAL FIELD

This disclosure relates to technical fields of an information processing system, an information processing apparatus, an information processing method, and a recording medium.

### BACKGROUND ART

A known system of this type performs learning on a speech recognizer. For example, Patent Literature 1 discloses a technique/technology in which speech patterns are sequentially inputted to a neural network that has performed initial learning, thereby to acquire a speech recognition result, and in which a pattern that causes misrecognition at that time is selected as an input pattern for additional learning. Patent Literature 2 discloses that learning is performed by using a training data set including a voice signal, text and attribute information corresponding to the voice signal.

As another related art, Patent Literature 3 discloses that a speech waveform is generated on the basis of an attribute symbol indicating an attribute of text, such as a title and an outline.

### CITATION LIST

### Patent Literature

Patent Literature 1: JPH08-146996A
Patent Literature 2: JP2020-154076A
Patent Literature 3: JPH06-044247A

### SUMMARY

### Technical Problem

This disclosure aims to improve the techniques/technologies disclosed in Citation List.

### Solution to Problem

An information processing system according to an example aspect of this disclosure includes: a first text data acquisition unit that acquires first text data; a speech data generation unit that generates first speech data corresponding to the first text data; a context symbol acquisition unit that acquires a context symbol corresponding to a word included in the first text data; a text data generation unit that generates second text data by inserting the context symbol into the first text data; and a learning unit that performs learning of a speech recognition unit that generates, from speech data, text data corresponding to the speech data, by using the first speech data and the second text data as inputs.

An information processing apparatus according to an example aspect of this disclosure includes: a first text data acquisition unit that acquires first text data; a speech data generation unit that generates first speech data corresponding to the first text data; a context symbol acquisition unit that acquires a context symbol corresponding to a word included in the first text data; a text data generation unit that generates second text data by inserting the context symbol into the first text data; and a learning unit that performs learning of a speech recognition unit that generates, from speech data, text data corresponding to the speech data, by using the first speech data and the second text data as inputs.

An information processing method according to an example aspect of this disclosure is an information processing method executed by at least one computer, the information processing method including: acquiring first text data; generating first speech data corresponding to the first text data; acquiring a context symbol corresponding to a word included in the first text data; generating second text data by inserting the context symbol into the first text data; and performing learning of a speech recognition unit that generates, from speech data, text data corresponding to the speech data, by using the first speech data and the second text data as inputs.

A recording medium according to an example aspect of this disclosure is a recording medium on which a computer program that allows at least one computer to execute an information processing method is recorded, the information processing method including: acquiring first text data; generating first speech data corresponding to the first text data; acquiring a context symbol corresponding to a word included in the first text data; generating second text data by inserting the context symbol into the first text data; and performing learning of a speech recognition unit that generates, from speech data, text data corresponding to the speech data, by using the first speech data and the second text data as inputs.

### BRIEF DESCRIPTION OF DRAWINGS

FIG. 1 is a block diagram illustrating a hardware configuration of an information processing system according to a first example embodiment.

FIG. 2 is a block diagram illustrating a functional configuration of an information processing system according to the first example embodiment.

FIG. 3 is a table illustrating an example of first text data, a context symbol, and second text data.

FIG. 4 is a flowchart illustrating a flow of operation by the information processing system according to the first example embodiment.

FIG. 5 is a block diagram illustrating a functional configuration of an information processing system according to a second example embodiment.

FIG. 6 is a table illustrating an example of a word and a context symbol stored in a dictionary database.

FIG. 7 is a block diagram illustrating a functional configuration of an information processing system according to a third example embodiment.

FIG. 8 is a flowchart illustrating a flow of an update operation by the information processing system according to the third example embodiment.

FIG. 9 is a block diagram illustrating a functional configuration of an information processing system according to a fourth example embodiment.

FIG. 10 is a flowchart illustrating a flow of a word addition operation by the information processing system according to the fourth example embodiment.

FIG. 11 is a block diagram illustrating a functional configuration of an information processing system according to a fifth example embodiment.

FIG. 12 is a flowchart illustrating a flow of a word addition operation by the information processing system according to the fifth example embodiment.

FIG. 13 is a block diagram illustrating a functional configuration of an information processing system according to a sixth example embodiment.

FIG. 14 is a table illustrating an example of a word, a context symbol, and a context example stored in the dictionary database.

FIG. 15 is a flowchart illustrating a flow of a word addition operation by the information processing system according to the sixth example embodiment.

FIG. 16 is a block diagram illustrating a functional configuration of an information processing system according to a seventh example embodiment.

FIG. 17 is a flowchart illustrating a flow of operation by the information processing system according to the seventh example embodiment.

### DESCRIPTION OF EXAMPLE EMBODIMENTS

Hereinafter, an information processing system, an information processing method, and a recording medium according to example embodiments will be described with reference to the drawings.

### First Example Embodiment

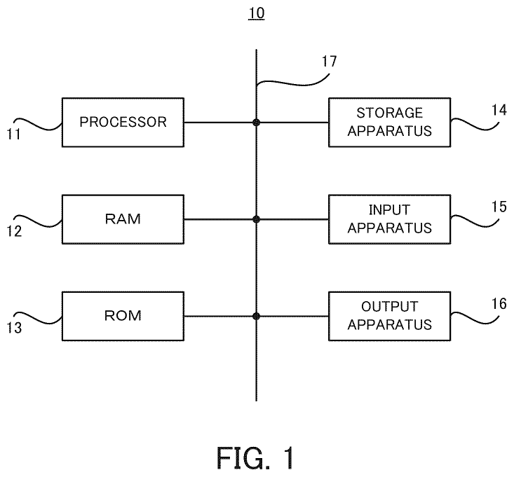

An information processing system according to a first example embodiment will be described with reference to FIG. 1 to FIG. 5.

### (Hardware Configuration)

First, a hardware configuration of the information processing system according to the first example embodiment will be described with reference to FIG. 1. FIG. 1 is a block diagram illustrating the hardware configuration of the information processing system according to the first example embodiment.

As illustrated in FIG. 1, an information processing system 10 according to the first example embodiment includes a processor 11, a RAM (Random Access Memory) 12, a ROM (Read Only Memory) 13, and a storage apparatus 14. The information processing system 10 may further include an input apparatus 15 and an output apparatus 16. The processor 11, the RAM 12, the ROM 13, the storage apparatus 14, the input apparatus 15, and the output apparatus 16 are connected through a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer-readable recording medium, by using a not-illustrated recording medium reading apparatus. The processor 11 may acquire (i.e., may read) a computer program from a not-illustrated apparatus disposed outside the information processing system 10, through a network interface. The processor 11 controls the RAM 12, the storage apparatus 14, the input apparatus 15, and the output apparatus 16 by executing the read computer program. Especially in the present example embodiment, when the processor 11 executes the read computer program, a functional block for performing learning of a speech recognizer, is realized or implemented in the processor 11. That is, the processor 11 may function as a controller for executing each control of the information processing system 10.

The processor 11 may be configured as, for example, a CPU (Central Processing Unit), a GPU (Graphics Processing Unit), a FPGA (field-programmable gate array), a DSP (Demand-Side Platform), or an ASIC (Application Specific Integrated Circuit). The processor 11 may be one of them, or may use a plurality of them in parallel.

The RAM 12 temporarily stores the computer program to be executed by the processor 11. The RAM 12 temporarily stores the data that are temporarily used by the processor 11 when the processor 11 executes the computer program. The RAM 12 may be, for example, a D-RAM (Dynamic RAM).

The ROM 13 stores the computer program to be executed by the processor 11. The ROM 13 may otherwise store fixed data. The ROM 13 may be, for example, a P-ROM (Programmable ROM).

The storage apparatus 14 stores the data that are stored for a long term by the information processing system 10. The storage apparatus 14 may operate as a temporary storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing system 10. The input apparatus 15 may include, for example, at least one of a keyboard, a mouse, and a touch panel. The input apparatus 15 may be configured as a portable terminal such as a smartphone and a tablet.

The output apparatus 16 is an apparatus that outputs information about the information processing system 10 to the outside. For example, the output apparatus 16 may be a display apparatus (e.g., a display) that is configured to display the information about the information processing system 10. The output apparatus 16 may be a speaker or the like that is configured to audio-output the information about the information processing system 10. The output apparatus 16 may be configured as a portable terminal such as a smartphone and a tablet.

Although FIG. 1 illustrates the information processing system 10 including a plurality of apparatuses, all or a part of the functions thereof may be realized by a single apparatus (information processing apparatus). The information processing apparatus may include only the processor 11, the RAM12, and the ROM13, for example, and an external apparatus connected to the information processing apparatus may include the other components (i.e., the storage apparatus 14, the input apparatus 15, and the output apparatus 16), for example. In the information processing apparatus, a part of an arithmetic function may also be realized by an external apparatus (e.g., an external server or cloud).

### (Functional Configuration)

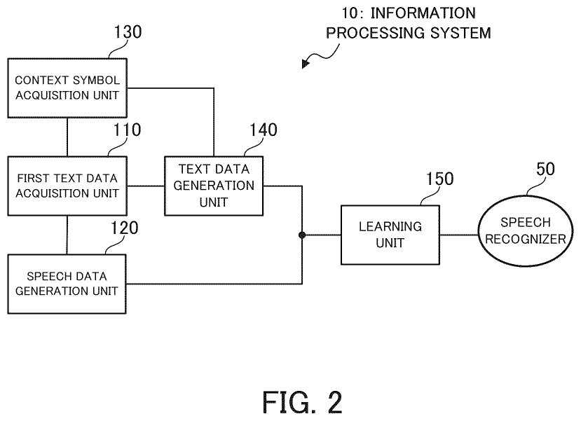

Next, a functional configuration of the information processing system 10 according to the first example embodiment will be described with reference to FIG. 2. FIG. 2 is a block diagram illustrating the functional configuration of the information processing system according to the first example embodiment.

As illustrated in FIG. 2, the information processing system 10 according to the first example embodiment is configured to perform learning of a speech recognizer 50. The speech recognizer 50 is an apparatus that generates text data from speech data. The learning of the speech recognizer 50 is performed to generate the text data with higher accuracy, for example. The learning of the speech recognizer 50 may be learning a conversion model (i.e., a model for converting the speech data into the text data) used by the speech recognizer 50. The information processing system 10 according to the first example embodiment does not include the speech recognizer 50 itself as a component, but may be configured as a system including the speech recognizer 50.

The information processing system 10 according to the first example embodiment includes, as components for realizing the functions thereof, a first text data acquisition unit 110, a speech data generation unit 120, a context symbol acquisition unit 130, a text data generation unit 140, and a learning unit 150. Each of the first text data acquisition unit 110, the speech data generation unit 120, the context symbol acquisition unit 130, the text data generation unit 140, and the learning unit 150 may be, for example, a processing block that is realized or implemented by the processor 11 (see FIG. 1).

The first text data acquisition unit 110 is configured to acquire first text data. The first text data are text data acquired for the learning of the speech recognizer. The first text data may be, for example, data including only words, or text data in a form of sentences. The first text data acquisition unit 110 may acquire a plurality of first text data. The first text data acquisition unit 110 may acquire the first text data by voice input/voice dictation. That is, the speech data may be converted into text data and acquired as the first text data.

The speech data generation unit 120 is configured to generate first speech data from the first text data acquired by the first text data acquisition unit 110. That is, the speech data generation unit 120 has a function of converting the text data into speech data. Since a method of converting text data into speech data, can adopt the existing techniques/technologies as appropriate, a detailed description thereof is omitted here.

The context symbol acquisition unit 130 is configured to acquire a context symbol corresponding to a word included in the first text data acquired by the first text data acquisition unit 110. The context symbol is information indicating how the word is used in a context. The context symbol may indicate a category of the word such as “person's name,” “place name,” “organization name,” and “product name,” or may indicate a part of speech of the word such as “noun,” and “verb.” The context symbol acquisition unit 130 may acquire the context symbol for each of a plurality of words in a case where the first text data include the plurality of words. In this instance, the context symbol acquisition unit 130 may acquire the context symbol for all the words included in the first text data, or may acquire the context symbol only for a part of the words. A method of acquiring the context symbol will be described in detail in another example embodiment described later.

The text data generation unit 140 is configured to generate second text data. Specifically, the text data generation unit 140 generates the second text data by inserting the context symbol acquired by the context symbol acquisition unit 130 into the first text data acquired by the first text data acquisition unit 110. That is, the second text data are data including the first text data and the context symbol. A method of generating the second text data will be described in more detail later.

The learning unit 150 is configured to perform the learning of the speech recognizer 50 by using the first speech data generated by the speech data generation unit 120 and the second text data generated by the text data generation unit 140. That is, the learning unit 150 is configured to perform the learning by using a set of the first speech data and the second text data that correspond to each other. In particular, since the context symbol is inserted to the second text data, not only the text, but also the context symbol is considered in the learning by the learning unit 150.

### (Example of Generating Second Text Data)

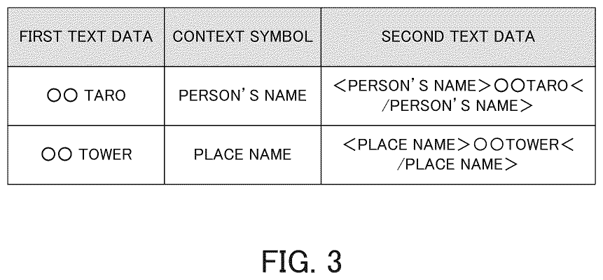

Next, an example of generating the second text data will be described with reference to FIG. 3. FIG. 3 is a table illustrating an example of the first text data, the context symbol, and the second text data.

As illustrated in FIG. 3, it is assumed that the first text data acquisition unit 110 acquires first text data of “OO Taro”. In this instance, the context symbol acquisition unit 130 acquires a context symbol of “person's name”. The text data generation unit 140 generates the second text data by inserting the context symbol of “person's name” in the text data of “OO Taro.” Specifically, the text data generation unit 140 generates the second text data of “<person's name> OO Taro </person's name>”

Next, it is assumed that the first text data acquisition unit 110 acquires first text data of “OO Tower”. In this instance, the context symbol acquisition unit 130 acquires a context symbol of “place name”. The text data generation unit 140 generates the second text data by inserting the context symbol of “place name” into the text data of “OO Tower.” Specifically, the text data generation unit 140 generates the second text data of “<place name> OO Tower </place name>”.

The above describes an example of inserting the context symbol before and after the word, but an insertion position of the context symbol is not particularly limited. For example, the context symbol may be inserted only before the word. Specifically, the second text data such as “<person's name> OO Taro” or “<place name>00 Tower” may be generated. The context symbol may also be inserted only after the word. Specifically, the second text data such as “00 Taro </person's name>” or “OO Tower </place name>” may be generated.

In a case where the first text data are in the sentence form, the context symbol may be inserted at a position of each word. For example, in a case where first text data of “we set up a meeting with Mr. D today” are acquired, the text data generation unit 140 may set second text data of “we set up a meeting with <person's name>Mr. D</person's name> <time> today </time>.”

### (Flow of Operation)

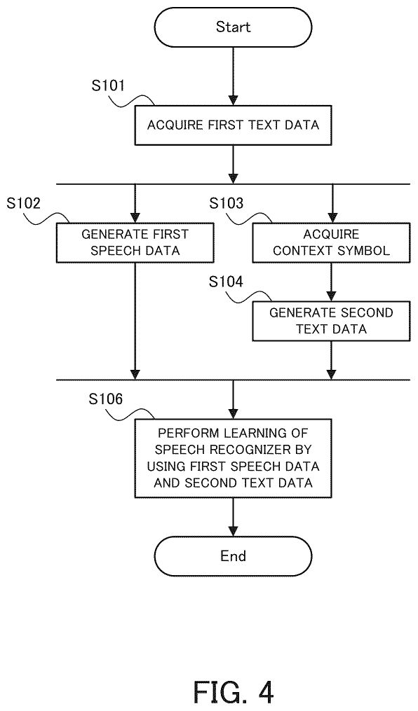

Next, a flow of operation (i.e., an operation in the learning of the speech recognizer 50) by the information processing system 10 according to the first example embodiment will be described with reference to FIG. 4. FIG. 4 is a flowchart illustrating the flow of the operation by the information processing system according to the first example embodiment.

As illustrated in FIG. 4, in operation of the information processing system 10 according to the first example embodiment, first, the first text data acquisition unit 110 acquires the first text data (step S101). The first text data acquired by the first text data acquisition unit 110 are outputted to each of the speech data generation unit 120, the context symbol acquisition unit 130, and the text data generation unit 140.

Subsequently, the speech data generation unit 120 generates the first speech data from the first text data (step S102). The first speech data generated by the speech data generation unit 120 are outputted to the learning unit 150.

On the other hand, the context symbol acquisition unit 130 acquires the context symbol corresponding to the word included in the first text data (step S103). The context symbol acquired by the context symbol acquisition unit 130 is outputted to the text data generation unit 140. The text data generation unit 140 generates the second text data by inserting the context symbol acquired by the context symbol acquisition unit 130 into the first text data acquired by the first text data acquisition unit 110 (step S104). The second text data generated by the text data generation unit 140 are outputted to the learning unit 150.

Subsequently, the learning unit 150 performs the learning of the speech recognizer 50 by using the first speech data generated by the speech data generation unit 120 and the second text data generated by the text data generation unit 140 (step S106). A series of processing steps described above may be repeatedly performed at each time when the first text data are acquired.

### (Technical Effect)

Next, a technical effect obtained by the information processing system 10 according to the first example embodiment will be described.

As described in FIG. 1 to FIG. 4, in the information processing system 10 according to the first example embodiment, the learning of the speech recognizer 50 is performed by using the second text data including the context symbol. In this way, the context symbol is considered in the learning of the speech recognizer 50. As a result, it is possible to perform the learning in consideration of how the word included in the first text data are used in a context. Therefore, it is possible to learn the speech recognizer more properly.

### Second Example Embodiment

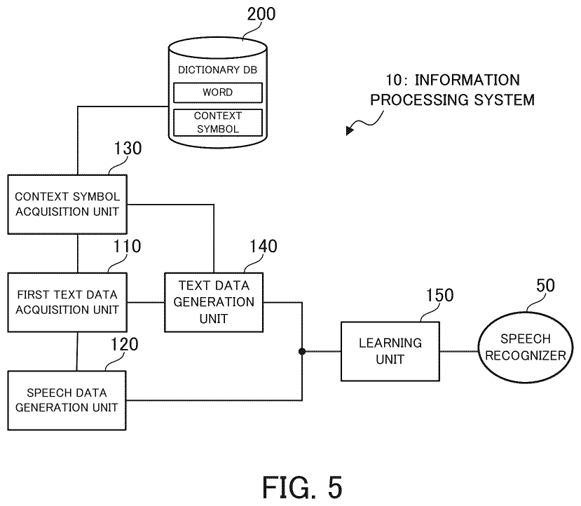

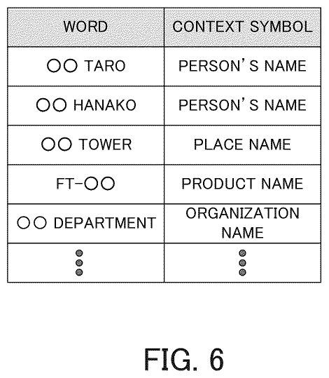

The information processing system 10 according to a second example embodiment will be described with reference to FIG. 5 and FIG. 6. The second example embodiment is partially different from the first example embodiment only in the configuration and operation, and may be the same as the first example embodiment in the other parts. For this reason, a part that is different from the first example embodiment will be described in detail below, and a description of other overlapping parts will be omitted as appropriate.

### (Functional Configuration)

First, a functional configuration of the information processing system 10 according to the second example embodiment will be described with reference to FIG. 5. FIG. 5 is a block diagram illustrating the functional configuration of the information processing system according to the second example embodiment. In FIG. 5, the same components as those illustrated in FIG. 2 carry the same reference numerals.

As illustrated in FIG. 5, the information processing system 10 according to the second example embodiment includes, as components for realizing the functions thereof, the first text data acquisition unit 110, the speech data generation unit 120, the context symbol acquisition unit 130, the text data generation unit 140, the learning unit 150, and a dictionary database (DB) 200. That is, the information processing system 10 according to the second example embodiment further includes the dictionary database 200 in addition to the configuration in the first example embodiment already described (see FIG. 2). The dictionary database 200 may be realized or implemented by the storage apparatus 14 (see FIG. 1), for example.

The dictionary database 200 is configured to store the word and the context in association with each other. The dictionary database 200 may store a plurality of sets of a single word and a single context, for example. Information about the word and the context stored in the dictionary database 200 (hereinafter referred to as “dictionary data” as appropriate) is configured to be properly read by the context symbol acquisition unit 130. The dictionary data may be inputted in advance by a user or the like. The dictionary data may also be configured to be manually or automatically updated (e.g., changed, added, deleted, etc.). The update of the dictionary data will be described in detail in another example embodiment described later.

The context symbol acquisition unit 130 according to the second example embodiment is configured to acquire the context symbol by using the dictionary database 200. The context symbol acquisition unit 130 confirms whether or not the word included in the first text data is registered in the dictionary database 200, and, if the work is registered, the context symbol acquisition unit 130 acquires the context symbol stored in association with the word. For the word that is not registered in the dictionary database 200, the context symbol may not be acquired, or the context symbol may be acquired by using a unit other than the dictionary database 200.

### Specific Example of Dictionary Data

Next, the dictionary data stored in the dictionary database 200 will be specifically described with reference to FIG. 6. FIG. 6 is a table illustrating an example of the word and the context symbol stored in the dictionary database.

As illustrated in FIG. 6, the dictionary database 200 stores therein a plurality of words and context symbols in association with each other. In the example illustrated in FIG. 6, a word of “OO Taro” and the context symbol of “person's name” are stored in association with each other.

A word of “OO Hanako” and the context symbol of “person's name” are stored in association with each other. A word of “OO Tower” and the context symbol of “place name” are stored in association with each other. A word of “FT-OO” and a context symbol of “product name” are stored in association with each other. A word of “OO Department” and a context symbol of “organization name” are stored in association with each other.

Although an example of storing a set of a single word and a single context symbol is illustrated here, the dictionary database 200 may store a plurality of context symbols in association with a single word. For example, the dictionary database 200 may store the context symbol of “person's name” and a context symbol of “noun” in association with the word of “OO Taro”.

### (Technical Effect)

Next, a technical effect obtained by the information processing system 10 according to the second example embodiment will be described.

As described in FIG. 5 and FIG. 6, in the information processing system 10 according to the second example embodiment, the context symbol is acquired by using the dictionary database 200. In this way, it is possible to acquire an appropriate context symbol, more easily.

### Third Example Embodiment

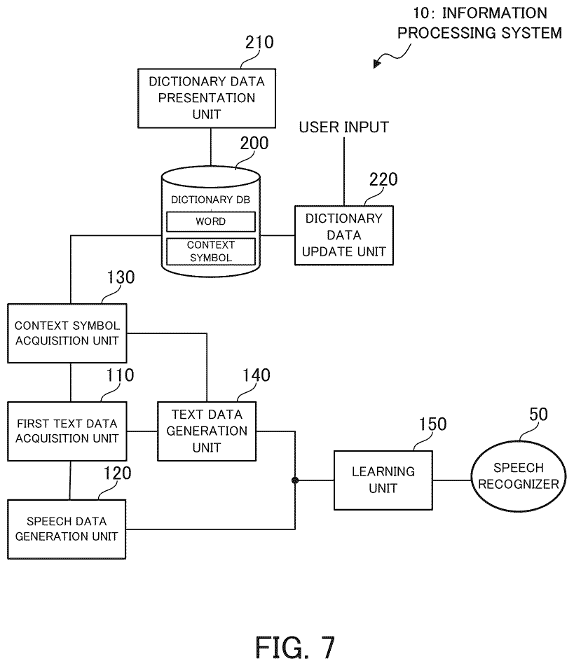

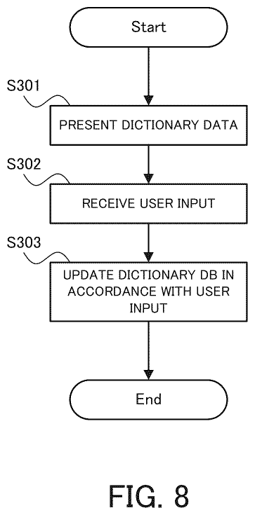

The information processing system 10 according to a third example embodiment will be described with reference to FIG. 7 and FIG. 8. The third example embodiment is partially different from the second example embodiment only in the configuration and operation, and may be the same as the first and second example embodiments in the other parts. For this reason, a part that is different from each of the example embodiments described above will be described in detail below, and a description of other overlapping parts will be omitted as appropriate.

### (Functional Configuration)

First, a functional configuration of the information processing system 10 according to the third example embodiment will be described with reference to FIG. 7. FIG. 7 is a block diagram illustrating the functional configuration of the information processing system according to the third example embodiment. In FIG. 7, the same components as those illustrated in FIG. 5 carry the same reference numerals.

As illustrated in FIG. 7, the information processing system 10 according to the third example embodiment includes, as components for realizing the functions thereof, the first text data acquisition unit 110, the speech data generation unit 120, the context symbol acquisition unit 130, the text data generation unit 140, the learning unit 150, the dictionary database 200, a dictionary data presentation unit 210, and a dictionary data update unit 220. That is, the information processing system 10 according to the third example embodiment further includes the dictionary data presentation unit 210 and the dictionary data update unit 220, in addition to the configuration in the second example embodiment already described (see FIG. 5). The dictionary data presentation unit 210 may be realized or implemented by using the output apparatus 16 (see FIG. 1), for example. The dictionary datum update unit 220 may be a processing block realized or implemented by the processor 11 (see FIG. 1), for example.

The dictionary data display unit 210 is configured to present the dictionary data stored in the dictionary database 200 to the user. A method of presenting the dictionary data by the dictionary data presentation unit 210 is not particularly limited. For example, the dictionary data display unit 210 may display the dictionary data to the user through a display. Alternatively, the dictionary data presentation unit 210 may output the dictionary data through a speaker.

The dictionary data update unit 220 is configured to update the dictionary data in the dictionary database 200 in response to an operation by the user who receives the presentation of the dictionary data. For example, in a case where the user performs an operation of inputting a new word and a new context symbol, the dictionary data update unit 220 may perform a processing of newly adding the word and the context symbol to the dictionary database 200. Furthermore, in a case where the user performs an operation of changing (correcting) the context symbol associated with the word that is already registered, the dictionary data update unit 220 may perform a processing of rewriting the dictionary database 200 to the changed one. In addition, in a case where the user performs an operation of deleting the word and the context symbol that are already registered, the dictionary data update unit 220 may perform a processing of deleting the word and the context symbol from the dictionary database 200.

### (Update Operation)

Next, a flow of an operation of updating the dictionary database 200 (hereinafter referred to as an “update operation” as appropriate) in the information processing system 10 according to the third example embodiment will be described with reference to FIG. 8. FIG. 8 is a flowchart illustrating the flow of the update operation by the information processing system according to the third example embodiment.

As illustrated in FIG. 8, when the update operation of the information processing system according to the third example embodiment is started, first, the dictionary data display unit 210 presents the dictionary data stored in the dictionary database 200 to the user (step S301). The dictionary data presentation unit 210 may present all the stored dictionary data (e.g., may display the dictionary data in a list format) or may present only a part of the dictionary data.

Subsequently, the dictionary data update unit 220 receives an input by the user who receives the presentation of the dictionary data (step S302). Then, the dictionary data update unit 220 updates the dictionary data stored in the dictionary database 200 in response to the user input (step S303). Note that the update operation of updating the dictionary data may be performed separately from the operation of performing the learning of the speech recognizer 50 described in the first example embodiment (see FIG. 4) (e.g., before the operation of learning is started). The update operation of updating the dictionary data, however, may be performed, simultaneously, in parallel with the operation of learning the speech recognizer 50.

### (Technical Effect)

Next, a technical effect obtained by the information processing system 10 according to the third example embodiment will be described.

As described in FIG. 7 and FIG. 8, in the information processing system 10 according to the third example embodiment, the dictionary data are updated in response to the user input. In this way, new dictionary data may be added, or inappropriate dictionary data may be corrected or deleted. Consequently, the context symbol acquisition unit 130 is allowed to acquire a more appropriate context symbol.

### Fourth Example Embodiment

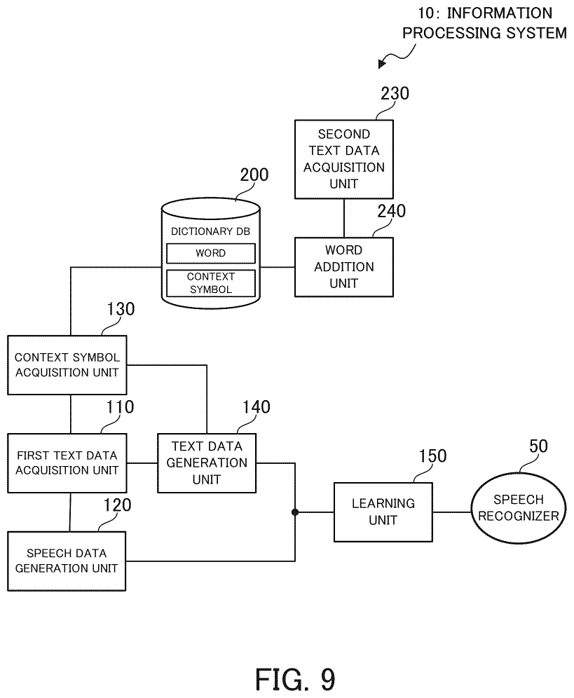

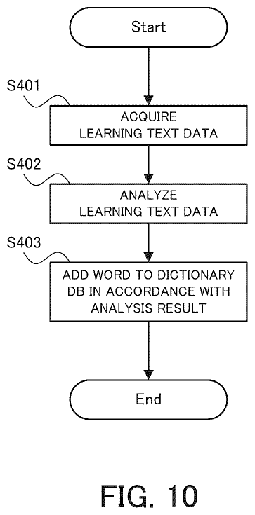

The information processing system 10 according to a fourth example embodiment will be described with reference to FIG. 9 and FIG. 10. The fourth example embodiment is partially different from the second and third example embodiments only in the configuration and operation, and may be the same as the first to third example embodiments in the other parts. For this reason, a part that is different from each of the example embodiments described above will be described in detail below, and a description of other overlapping parts will be omitted as appropriate.

### (Functional Configuration)

First, a functional configuration of the information processing system 10 according to the fourth example embodiment will be described with reference to FIG. 9. FIG. 9 is a block diagram illustrating the functional configuration of the information processing system according to the fourth example embodiment. In FIG. 9, the same components as those illustrated in FIG. 5 carry the same reference numerals.

As illustrated in FIG. 9, the information processing system 10 according to the fourth example embodiment includes, as components for realizing the function thereof, the first text data acquisition unit 110, the speech data generation unit 120, the context symbol acquisition unit 130, the text data generation unit 140, the learning unit 150, the dictionary database 200, a second text data acquisition unit 230, and a word addition unit 240. That is, the information processing system 10 according to the fourth example embodiment further includes the second text data acquisition unit 230 and the word addition unit 240, in addition to the configuration in the second example embodiment already described (see FIG. 5). Each of the second text data acquisition unit 230 and the word addition unit 240 may be a processing block realized or implemented by the processor 11 (see FIG. 1), for example.

The second text data acquisition unit 230 is configured to acquire learning text data for learning the dictionary database 200 (i.e., for adding new dictionary data). The learning text data may be text data that do not include the context symbol (e.g., text data including only words or sentences) or may be text data that include the context symbol (e.g., text data in the same format as that of the second text data). The second text data acquisition unit 230 may acquire a plurality of learning text data. The second text data acquisition unit 230 may acquire the learning text data by voice input/voice dictation. That is, the speech data may be converted into text data and acquired as the learning text data.

The word addition unit 240 is configured to add the word included in the learning text data, to the dictionary database 200. The word addition unit 240 may have a function of analyzing the learning text data and extracting the included word. In a case where the second text data include a plurality of words, The word appending unit 240 may add all or a part of the plurality of words to the dictionary database 200. The word appending unit 240 may automatically select the word to be added to the dictionary database 200, or may select it in response to an input by the user or the like. A specific method of adding the word by the word addition unit 240 will be described in detail in another example embodiment described below. (Word Addition Operation)

Next, a flow of an operation of adding a new word to the dictionary database 200 (hereinafter referred to as a “word addition operation” as appropriate) in the information processing system 10 according to the fourth example embodiment will be described with reference to FIG. 10. FIG. 10 is a flowchart illustrating the flow of the word addition operation by the information processing system according to the fourth example embodiment.

As illustrated in FIG. 10, when the word addition operation of the information processing system 10 according to the fourth example embodiment is started, first, the second text data acquisition unit 230 acquires the learning text data (step S401). The learning text data acquired by the second text data acquisition unit 230 are outputted to the word addition unit 240.

Subsequently, the word addition unit 240 analyzes the learning text data (step S402). For example, the word addition unit 240 analyzes the learning text data and extracts the word included therein. Then, the word addition unit 240 adds the word included in the learning text data, to the dictionary database 200 (step S403).

### (Technical Effect)

Next, a technical effect obtained by the information processing system 10 according to the fourth example embodiment will be described.

As described in FIG. 9 and FIG. 10, in the information processing system 10 according to the fourth example embodiment, a new word is added to the dictionary database 200 by using the learning text data. In this way, it is possible to easily increase the number of words registered in the dictionary database 200. Consequently, the context symbol acquisition unit 130 is allowed to acquire a more appropriate context symbol.

### Fifth Example Embodiment

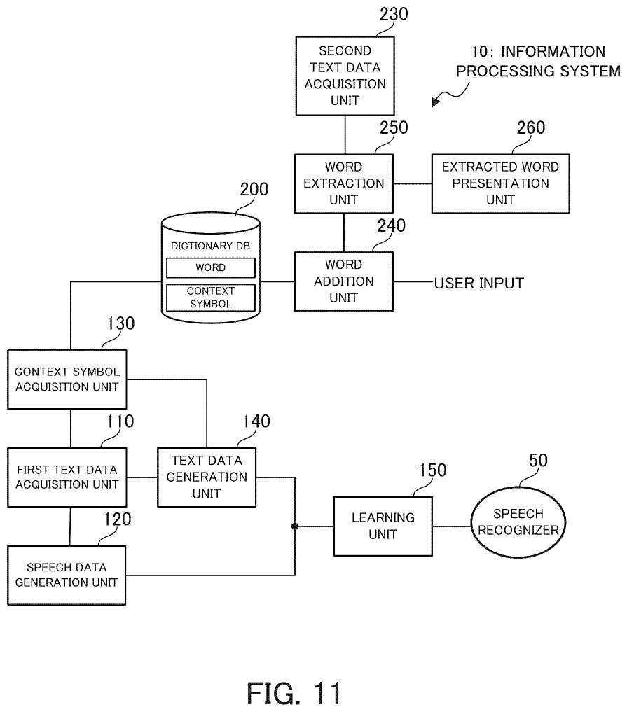

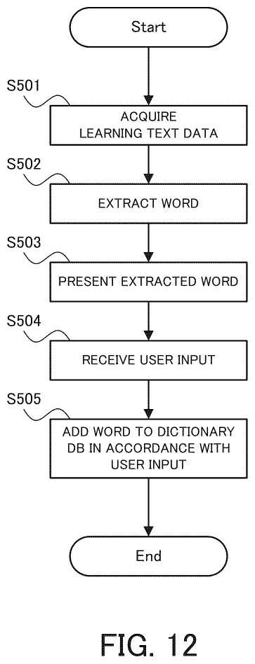

The information processing system 10 according to a fifth example embodiment will be described with reference to FIG. 11 and FIG. 12. The fifth example embodiment is partially different from the fourth example embodiment only in the configuration and operation, and may be the same as the first to fourth example embodiments in the other parts. For this reason, a part that is different from each of the example embodiments described above will be described in detail below, and a description of other overlapping parts will be omitted as appropriate.

### (Functional Configuration)

First, a functional configuration of the information processing system 10 according to the fifth example embodiment will be described with reference to FIG. 11. FIG. 11 is a block diagram illustrating the functional configuration of the information processing system according to the fifth example embodiment. In FIG. 11, the same components as those illustrated in FIG. 9 carry the same reference numerals.

As illustrated in FIG. 11, the information processing system 10 according to the fifth example embodiment includes, as components for realizing the function thereof, the first text data acquisition unit 110, the speech data generation unit 120, the context symbol acquisition unit 130, the text data generation unit 140, the learning unit 150, the dictionary database 200, the second text data acquisition unit 230, the word addition unit 240, a word extraction unit 250, and an extracted word display unit 260. That is, the information processing system 10 according to the fifth example embodiment further includes the word extraction unit 250 and the extracted word presentation unit 260, in addition to the configuration in the fourth example embodiment already described (see FIG. 9). The word extraction unit 250 may be a processing block realized or implemented by the processor 11 (see FIG. 1), for example. The extracted word presentation unit 260 may be realized or implemented by using the output apparatus 16 (see FIG. 1), for example.

The word extraction unit 250 is configured to extract the word from the learning text data acquired by the second text data acquisition unit. The word extraction unit 250 may extract all or only a part of the words included in the learning text data. The word extraction unit 250 may extract only the word that is not registered in the dictionary database 200 from among the words included in the learning text data, for example.

The extracted word presentation unit 260 is configured to present the word extracted by the word extraction unit 250, to the user. A method of presenting the extracted word by the extraction word presentation unit 260 is not particularly limited. For example, the extracted word presentation unit 260 may display the extracted word to the user through a display. Alternatively, the extracted word presentation unit 260 may output the extracted word through a speaker.

The word addition unit 240 according to the present example embodiment is configured to add the word to the dictionary data in the dictionary database 200, in response to an operation by the user who receives the presentation of the extracted word. For example, in a case where the user selects at least one of the extracted words, the word addition unit 240 may perform a processing of newly adding the word selected by the user, to the dictionary database 200. Furthermore, in a case where the user performs an operation of associating the context symbol with the extracted word (e.g., an operation of inputting the context symbol associated with the word), the word addition unit 240 may perform a processing of newly adding the word and the context symbol to the dictionary database 200.

### (Word Addition Operation)

Next, a flow of the word addition operation in the information processing system 10 according to the fifth example embodiment will be described with reference to FIG. 12. FIG. 12 is a flowchart illustrating the flow of the word addition operation by the information processing system according to the fifth example embodiment.

As illustrated in FIG. 12, when the word addition operation of the information processing system 10 according to the fifth example embodiment is started, first, the second text data acquisition unit 230 acquires the learning text data (step S501). The learning text data acquired by the second text data acquisition unit 230 are outputted to the word extraction unit 250.

Subsequently, the word extraction unit 250 extracts the word from the learning text data (step S502). Information about the word extracted by the word extraction unit 250 is outputted to the extracted word presentation unit 260. Then, the extracted word presentation unit 260 presents the word extracted by the word extraction unit 250 to the user (step S503).

Subsequently, the word addition unit 240 receives an input by the user who receives the presentation of the extracted word (step S504). Then, the word addition unit 240 adds the word extracted by the word extraction unit 250 to the dictionary database 200 in response to the user input. (step S505)

### (Technical Effect)

Next, a technical effect obtained by the information processing system 10 according to the fifth example embodiment will be described.

As described in FIG. 11 and FIG. 12, in the information processing system 10 according to the fifth example embodiment, a new word is added to the dictionary database 200 in response to the user input. In this way, it is possible to increase the number of words registered in the dictionary database 200. Furthermore, a more appropriate context symbol is associated with the word by the user input. Consequently, the context symbol acquisition unit 130 is allowed to acquire a more appropriate context symbol.

### Sixth Example Embodiment

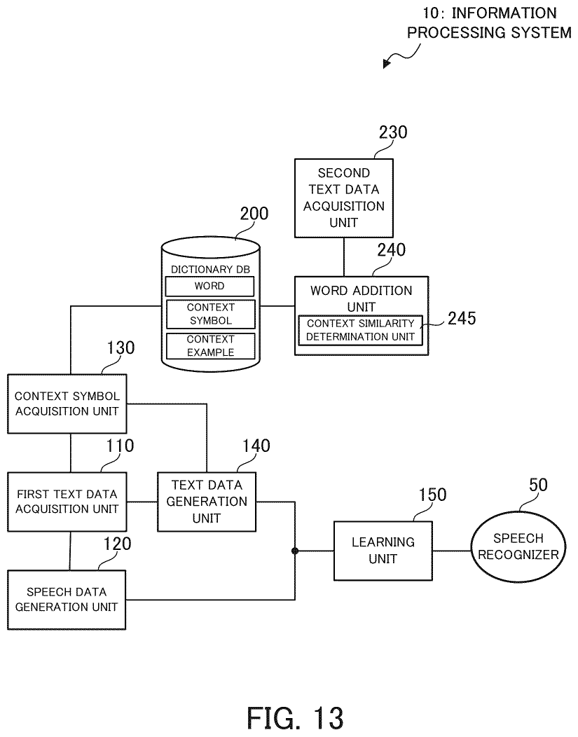

The information processing system 10 according to a sixth example embodiment will be described with reference to FIG. 13 to FIG. 15. The sixth example embodiment is partially different from the fourth and fifth example embodiments only in the configuration and operation, and may be the same as the first to fifth example embodiments in the other parts. For this reason, a part that is different from each of the example embodiments described above will be described in detail below, and a description of other overlapping parts will be omitted as appropriate.

### (Functional Configuration)

First, a functional configuration of the information processing system 10 according to the sixth example embodiment will be described with reference to FIG. 13. FIG. 13 is a block diagram illustrating the functional configuration of the information processing system according to the sixth example embodiment. In FIG. 13, the same components as those illustrated in FIG. 9 carry the same reference numerals.

As illustrated in FIG. 13, the information processing system 10 according to the sixth example embodiment includes, as components for realizing the functions thereof, the first text data acquisition unit 110, the speech data generation unit 120, the context symbol acquisition unit 130, the text data generation unit 140, the learning unit 150, the dictionary database 200, the second text data acquisition unit 230, and the word addition unit 240. In particular, the word addition unit 240 according to the sixth example embodiment includes a context similarity determination unit 245.

The dictionary database 200 according to the sixth example embodiment is configured to store a context example, in addition to the word and the context symbol. The dictionary database 200 stores therein a set of the word, the context symbol, and the context example, as the dictionary data, for example. The dictionary database 200 may be configured to store a plurality of context examples for a single word or a single context symbol. The context example may be, for example, one that is inputted in advance by the user, or one that is acquired in the updating of the dictionary database 200 (e.g., one that is included in the previous learning text data).

The context similar determination unit 245 determines whether or not a first context included in the learning text data acquired by the second text data acquisition unit 230 is similar to the context example stored in the dictionary database 200. The context similar determination unit 245 may calculate a degree of matching between the first context included in the learning text data and the context example stored in the dictionary database 200, and may determine that the first context is similar to the context example when the degree of matching is greater than or equal to a predetermined value.

The word addition unit 240 according to the present example embodiment is configured to add a new word to the dictionary database 200 in accordance with a determination result of the context similar determination unit 245. A method of adding the word in accordance with the determination result of the context similar determination unit 245 will be described in detail later.

The word addition unit 240 may be configured not only to add the word in accordance with the determination result of the context similar determination unit 245, but also to add the word in another way. For example, the word addition unit 240 may be configured to add the word in response to the user input, as described in the fifth example embodiment (see FIG. 11 and FIG. 12).

### (Specific Example of Dictionary Data)

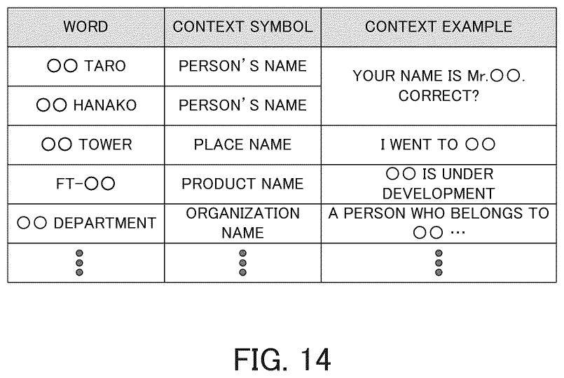

Next, the dictionary data stored in the dictionary database 200 according to the sixth example embodiment will be specifically described with reference to FIG. 14. FIG. 14 is a table illustrating an example of the word, the context symbol, and the context example stored in the dictionary database.

As illustrated in FIG. 14, the dictionary database 200 stores the word, the context symbol, and the context example in conjunction with one another. The context example may be stored primarily in association with the context symbol. In the example illustrated in FIG. 14, a context example of “Your name is Mr. OO, correct?” is stored in association with the context symbol of “person's name”. A context example of “I went to OO” is stored in association with the context symbol of “place name”. A context example of “OO is under development” is stored in association with the context symbol of “product name”. A context example of “a person who belongs to OO . . . ” is stored in association with the context symbol of “organizational name”.

Note that a plurality of context examples may be stored in association with a single context symbol. Furthermore, the context example may also be stored in association with each word. For example, different context examples may be stored in association with a common context symbol.

### (Word Addition Operation)

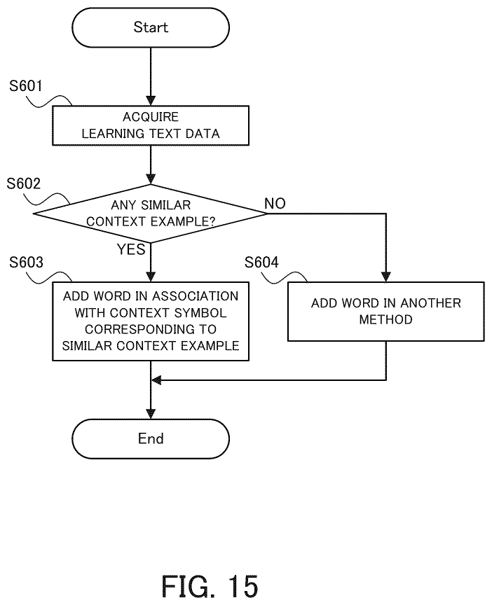

Next, a flow of the word addition operation in the information processing system 10 according to the sixth example embodiment will be described with reference to FIG. 15. FIG. 15 is a flowchart illustrating the flow of the word addition operation by the information processing system according to the sixth example embodiment.

As illustrated in FIG. 15, when the word addition operation of the information processing system 10 according to the sixth example embodiment is started, first, the second text data acquisition unit 230 acquires the learning text data (step S601). The learning text data acquired by the second text data acquisition unit 230 are outputted to the context similar determination unit 245 of the word addition unit 240.

Subsequently, the context similarity determination unit 245 determines whether or not the first context included in the learning text data acquired by the second text data acquisition unit 230 is similar to the context example stored in the dictionary database 200 (step S602).

When it is determined that the first context is similar to the context example (the step S602: YES), the word addition unit 240 stores the word included in the first context, in the dictionary database 200, as being associated with the context symbol stored in association with the context example determined to be similar (step S603). For example, in a case where the context symbol of “person's name” is stored in association with the context example of “Your name is Mr. OO, correct?”, and the learning text data include contexts of “Your name is Mr. A, correct?”, “Your name is Mr. B, correct?” and “Your name is Mr. C, correct?”, the words of “Mr. A”, “Mr. B”, and “Mr. C” are all stored as being associated with the context symbol of “person's name”.

On the other hand, when it is determined that the first context is not similar to the context example (the step S602: NO), the word addition unit 240 adds the word in a method that does not use the context example (step S604). For example, the word addition unit 240 may add the word in response to the user input, as described in the fifth example embodiment. Alternatively, the word addition unit 240 may not add the word.

### (Technical Effect)

Next, a technical effect obtained by the information processing system 10 according to the sixth example embodiment will be described.

As described in FIG. 13 to FIG. 15, in the information processing system 10 according to the sixth example embodiment, a new word is added to the dictionary database 200 by determining whether or not the contexts are similar. In this way, it is possible to easily increase the number of words registered in the dictionary database 200. Furthermore, by using the context example, a more appropriate context symbol is associated with the word. Consequently, the context symbol acquisition unit 130 is allowed to acquire a more appropriate context symbol.

### Seventh Example Embodiment

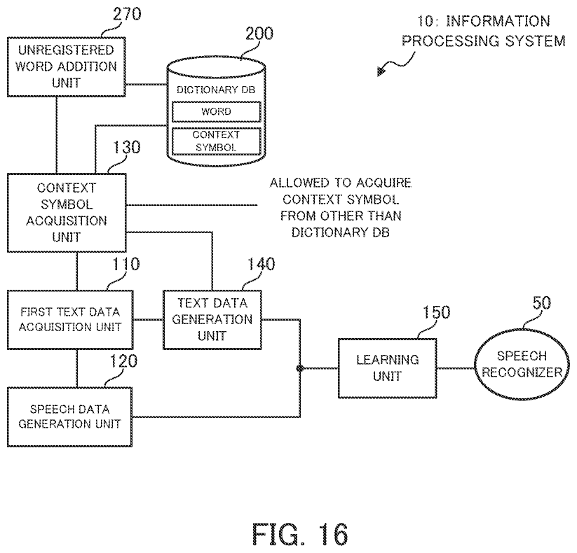

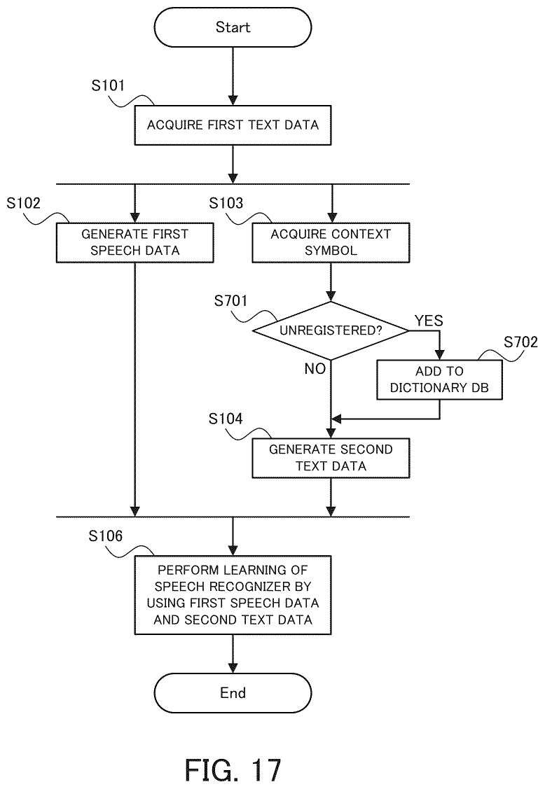

The information processing system 10 according to a seventh example embodiment will be described with reference to FIG. 16 and FIG. 17. The seventh example embodiment is partially different from the second to sixth example embodiments only in the configuration and operation, and may be the same as the first to sixth example embodiments in the other parts. For this reason, a part that is different from each of the example embodiments described above will be described in detail below, and a description of other overlapping parts will be omitted as appropriate.

### (Functional Configuration)

First, a functional configuration of the information processing system 10 according to the seventh example embodiment will be described with reference to FIG. 16. FIG. 16 is a block diagram illustrating the functional configuration of the information processing system according to the seventh example embodiment. In FIG. 16, the same components as those illustrated in FIG. carry the same reference numerals.

As illustrated in FIG. 16, the information processing system 10 according to the seventh example embodiment includes, as components for realizing the functions thereof, the first text data acquisition unit 110, the speech data generation unit 120, the context symbol acquisition unit 130, the text data generation unit 140, the learning unit 150, the dictionary database 200, and an unregistered word addition unit 270. That is, the information processing system 10 according to the seventh example embodiment further includes the unregistered word addition unit 270 in addition to the configuration in the second example embodiment already described (see FIG. 5). The unregistered word addition unit 270 may be a processing block realized or implemented by the processor 11 (see FIG. 1), for example.

The unregistered word addition unit 270 is configured to allow the dictionary database 200 to store therein an unregistered word, which is a word that is not stored in the dictionary database 200, and the context symbol acquired for the unregistered word, when the context symbol acquisition unit 130 acquires the context symbol corresponding to the unregistered word. The unregistered word addition unit 270 may determine that the context symbol corresponding to the unregistered word is acquired, when the context symbol acquisition unit 130 acquires the context symbol from a different path from the dictionary database 200 (i.e., without using the dictionary data), for example. The context symbol acquisition unit 130 may acquire the context symbol from a different path from the dictionary database 200, by using named-entity extraction/recognition, for example.

Note that the context symbol acquisition unit 130 according to the seventh example embodiment may be configured to acquire the context symbol from another database that is different from the dictionary database 200, for example. Alternatively, the context symbol acquisition unit 130 may be configured to acquire the context symbol in response to the user input. Alternatively, the context symbol acquisition unit 130 may be configured to automatically determine and acquire the context symbol suitable for the word.

### (Flow of Operation)

Next, a flow of operation by the information processing system 10 according to the seventh example embodiment will be described with reference to FIG. 17. FIG. 17 is a flowchart illustrating the flow of the operation performed by the information processing system according to the seventh example embodiment. In FIG. 17, the same steps as those illustrated in FIG. 4 carry the same reference numerals.

As illustrated in FIG. 17, in operation of the information processing system 10 according to the seventh example embodiment, first, the first text data acquisition unit 110 acquires the first text data (step S101). The first text data acquired by the first text data acquisition unit 110 are outputted to each of the speech data generation unit 120, the context symbol acquisition unit 130, and the text data generation unit 140.

Subsequently, the speech data generation unit 120 generates the first speech data from the first text data (step S102). The first speech data generated by the speech data generation unit 120 are outputted to the learning unit 150.

On the other hand, the context symbol acquisition unit 130 acquires the context symbol corresponding to the word included in the first text data (step S103). The context symbol acquired by the context symbol acquisition unit 130 is outputted to the text data generation unit 140 and the unregistered word addition unit 270.

Especially in the seventh example embodiment, the unregistered word addition unit 270 determines whether or not the context symbol acquisition unit 130 acquires the context symbol for the unregistered word (step S701). Then, when the context symbol is acquired for the unregistered word (the step S701: YES), the unregistered word addition unit 270 newly adds the unregistered word and the context symbol acquired for the unregistered word, to the dictionary database 200 (step S702). When the context symbol is not acquired for the unregistered word (the step S701: NO), the unregistered word addition unit 270 omits the step S702.

Subsequently, the text data generation unit 140 generates the second text data by inserting the context symbol acquired by the context symbol acquisition unit 130 into the first text data acquired by the first text data acquisition unit 110 (step S104). The second text data generated by the text data generation unit 140 are outputted to the learning unit 150.

Subsequently, the learning unit 150 performs the learning of the speech recognizer 50 by using the first speech data generated by the speech data generation unit 120 and the second text data generated by the text data generation unit 140 (step S106).

In the above example, the unregistered word addition unit 270 performs a processing of adding a new word and a new context symbol immediately after the acquisition of the context symbol (i.e., immediately after the step S103), but the unregistered word addition unit 270 may add the new word and the new context symbol in different timing. For example, the unregistered word addition unit 270 may perform the processing of adding a new word and a new context symbol after completion of the learning of speech recognizer 50 (i.e., after the step S106).

### (Technical Effect)

Next, a technical effect obtained by the information processing system 10 according to the seventh example embodiment will be described.

As described in FIG. 16 and FIG. 17, in the information processing system 10 according to the seventh example embodiment, a new word is added to the dictionary database 200 when the context symbol is acquired for the unregistered word. In this way, it is possible to increase the dictionary data while operating the system (i.e., while performing a processing of performing the learning of the speech recognizer 50).

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal.

### Supplementary Notes

The example embodiments described above may be further described as, but not limited to, the following Supplementary Notes below.

### Supplementary Note 1

An information processing system according to Supplementary Note 1 is an information processing system including: a first text data acquisition unit that acquires first text data; a speech data generation unit that generates first speech data corresponding to the first text data; a context symbol acquisition unit that acquires a context symbol corresponding to a word included in the first text data; a text data generation unit that generates second text data by inserting the context symbol into the first text data; and a learning unit that performs learning of a speech recognition unit that generates, from speech data, text data corresponding to the speech data, by using the first speech data and the second text data as inputs.

### Supplementary Note 2

An information processing system according to Supplementary Note 2 is the information processing system according to Supplementary Note 1, further including a storage unit that stores the word and the context symbol in association with each other, wherein the context symbol acquisition unit acquires the context symbol corresponding to the word included in the first text data, by using the storage unit.

### Supplementary Note 3

An information processing system according to Supplementary Note 3 is the information processing system according to Supplementary Note 2, further including: a first presentation unit that presents the word and the context symbol stored in the storage unit, to a user; and an update unit that updates at least one of the word and the context symbol stored in the storage unit, in response to an operation by the user who receives presentation by the first presentation unit.

### Supplementary Note 4

An information processing system according to Supplementary Note 4 is the information processing system according to Supplementary Note 2 or 3, further including: a second text data acquisition unit that acquires third text data; and a word addition unit that newly stores the word included in the third text data, in the storage unit.

### Supplementary Note 5

An information processing system according to Supplementary Note 5 is the information processing system according to Supplementary Note 4, further including: an extraction unit that extracts the word included in the third text data; a second presentation unit that presents the word extracted by the extraction unit, to a user, wherein the word addition unit stores the word extracted by the extraction unit, in the storage unit, in response to an operation by the user who receives presentation by the second presentation unit.

### Supplementary Note 6

An information processing system according to Supplementary Note 6 is the information processing system according to Supplementary Note 4 or 5, wherein the storage unit stores a context example corresponding to the word and the context symbol, in addition to the word and the context symbol, and the word addition unit stores a word included in a first context that is included in the third text data, in the storage unit, as being associated with the context symbol corresponding to a similar context example, in a case where the first context is similar to the context example stored in the storage unit.

### Supplementary Note 7

An information processing system according to Supplementary Note 7 is the information processing system according to any one of Supplementary Notes 2 to 6, wherein the context symbol acquisition unit is configured to acquire the context symbol from a different path from the storage unit, and the information processing system further comprises an unregistered word addition unit that stores an unregistered word, which is the word that is not stored in the storage unit, and the context symbol corresponding to the unregistered word, in the storage unit, in a case where the context symbol acquisition unit acquires the context symbol corresponding to the unregistered word.

### Supplementary Note 8

An information processing apparatus according to Supplementary Note 8 is an information processing apparatus including: a first text data acquisition unit that acquires first text data; a speech data generation unit that generates first speech data corresponding to the first text data; a context symbol acquisition unit that acquires a context symbol corresponding to a word included in the first text data; a text data generation unit that generates second text data by inserting the context symbol into the first text data; and a learning unit that performs learning of a speech recognition unit that generates, from speech data, text data corresponding to the speech data, by using the first speech data and the second text data as inputs.

### Supplementary Note 9

An information processing method according to Supplementary Note 9 is an information processing method executed by at least one computer, the information processing method including: acquiring first text data; generating first speech data corresponding to the first text data; acquiring a context symbol corresponding to a word included in the first text data; generating second text data by inserting the context symbol into the first text data; and performing learning of a speech recognition unit that generates, from speech data, text data corresponding to the speech data, by using the first speech data and the second text data as inputs.

### Supplementary Note 10

A recording medium according to Supplementary Note 10 is a recording medium on which a computer program that allows at least one computer to execute an information processing method is recorded, the information processing method including: acquiring first text data; generating first speech data corresponding to the first text data; acquiring a context symbol corresponding to a word included in the first text data; generating second text data by inserting the context symbol into the first text data; and performing learning of a speech recognition unit that generates, from speech data, text data corresponding to the speech data, by using the first speech data and the second text data as inputs.

### Supplementary Note 11

A computer program according to Supplementary Note 11 is a computer program that allows at least one computer to execute an information processing method, the information processing method including: acquiring first text data; generating first speech data corresponding to the first text data; acquiring a context symbol corresponding to a word included in the first text data; generating second text data by inserting the context symbol into the first text data; and performing learning of a speech recognition unit that generates, from speech data, text data corresponding to the speech data, by using the first speech data and the second text data as inputs.

This disclosure is allowed to be changed, if desired, without departing from the essence or spirit of this disclosure which can be read from the claims and the entire specification. An information processing system, an information processing apparatus, an information processing method, and a recording medium with such changes are also intended to be within the technical scope of this disclosure.

### DESCRIPTION OF REFERENCE CODES

10 Information processing system
11 Processor
14 Storage apparatus
50 Speech recognizer
110 First text data acquisition unit
120 Speech data generation unit
130 Context symbol acquisition unit
140 Text data generation unit
150 Learning unit
200 Dictionary database
210 Dictionary data presentation unit
220 Dictionary update unit
230 Second text data acquisition unit
240 Word addition unit
245 Context similarity determination unit
250 Word extraction unit
260 Extracted word presentation unit
270 Unregistered word addition unit

What is claimed is:

1. An information processing system comprising:
at least one memory that is configured to store instructions; and
at least one processor that is configured to execute the instructions to
acquire first text data;
generate first speech data corresponding to the first text data;
acquire a context symbol corresponding to a word included in the first text data;
generate second text data by inserting the context symbol into the first text data; and
perform learning of a speech recognition unit that generates, from speech data, text data corresponding to the speech data, by using the first speech data and the second text data as inputs.

2. The information processing system according to claim 1, wherein the at least one processor is configured to execute the instructions to:
store the word and the context symbol in association with each other, and
acquire the context symbol corresponding to the word included in the first text data.

3. The information processing system according to claim 2, wherein the at least one processor is configured to execute the instructions to:
present the word and the context symbol stored, to a user; and
update at least one of the word and the context symbol stored, in response to an operation by the user who receives presentation.

4. The information processing system according to claim 2, wherein the at least one processor is configured to execute the instructions to:
acquire third text data; and
newly store the word included in the third text data.

5. The information processing system according to claim 4, wherein the at least one processor is configured to execute the instructions to:
extract the word included in the third text data;
present the word extracted, to a user; and
store the word extracted, in response to an operation by the user who receives presentation.

6. The information processing system according to claim 4, wherein the at least one processor is configured to execute the instructions to:
store a context example corresponding to the word and the context symbol, in addition to the word and the context symbol, and
store a word included in a first context that is included in the third text data, as being associated with the context symbol corresponding to a similar context example, in a case where the first context is similar to the context example stored.

7. The information processing system according to claim 2, wherein the at least one processor is configured to execute the instructions to:
acquire the context symbol from a different path, and
store an unregistered word, which is the word that is not stored, and the context symbol corresponding to the unregistered word, in a case where the context symbol corresponding to the unregistered word is acquired.

8. (canceled)

9. An information processing method executed by at least one computer, the information processing method comprising:
acquiring first text data;
generating first speech data corresponding to the first text data;
acquiring a context symbol corresponding to a word included in the first text data;
generating second text data by inserting the context symbol into the first text data; and
performing learning of a speech recognition unit that generates, from speech data, text data corresponding to the speech data, by using the first speech data and the second text data as inputs.

10. A non-transitory recording medium on which a computer program that allows at least one computer to execute an information processing method is recorded, the information processing method including:
acquiring first text data;
generating first speech data corresponding to the first text data;
acquiring a context symbol corresponding to a word included in the first text data;
generating second text data by inserting the context symbol into the first text data; and
performing learning of a speech recognition unit that generates, from speech data, text data corresponding to the speech data, by using the first speech data and the second text data as inputs.
